(19) United States
(12) Patent Application Publication
(10) Pub. No.: US 2008/0021818 A1
(43) Pub. Date: Jan. 24, 2008

(54) Peer-To-Peer Electronic Marketplace For Advertising

(76) Inventor: Robert D. Fish, Tustin, CA (US)

Correspondence Address: FISH & ASSOCIATES, PC;ROBERT D. FISH, 2603 Main Street, Suite 1050, Irvine, CA, 92614-6232, US

(21) Appl. No.: 11/781,190

(22) Filed: Jul. 20, 2007

Related U.S. Application Data
(60) Provisional application No. 60/832,351, filed on Jul. 20, 2006.

(51) Int. Cl. G06F 17/30; G06Q 30/00; G06Q 40/00

(52) U.S. Cl. 705/39

(57) ABSTRACT

Advertisers and publishers use an electronic marketplace to: (1) make payments to each other rather than through a marketplace account; and/or (2) identify types, geographic locations, fees, and other relevant characteristics as parameter/value pairs, and add or at least suggest their own parameters.

This application claims priority to U.S. provisional application No. 60/832,351, filed Jul. 20, 2006, which is incorporated herein by reference herein in its entirety.

### FIELD OF THE INVENTION

The field of the invention is electronic marketplaces.

### BACKGROUND OF THE INVENTION

Advertising goods and services has a long history. With the advent of the Internet, many companies (e.g., Google™, Yahoo!™, and Microsoft™) generate large revenue streams by offering advertising services to entities who wish to have their message conveyed to consumers. Such companies generate revenue at the expense of advertisers, while offering only moderate payments to those that offer advertising opportunities. The bulk of the money remains in the company's coffers.

A better advertising system would allow advertisers to access advertising opportunities directly from those entities (referred to as “publishers” herein) that offer the opportunities. Such a system should also allow the advertisers and publishers to directly pay each other, as opposed to paying a brokering service for advertising. By having direct access to each other, entities have several advantages:
Elimination of the middle man between the entities
Entities that wish to advertise will extend their advertising dollar because they can target their message more appropriately
Entities that offer advertising opportunities generate more advertising revenue because they are paid directly
Strong peer-to-peer interaction between entities

U.S. Pat. No. 7,039,930 titled “Television advertising automated billing system” describes scheduling and billing for television advertising through a marketplace, but does not allow peers to find each other through an information system. The '930 patent, and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Some websites or search engines offer entities the ability to find other market relevant entities, but they do not provide marketplace infrastructure to make payments directly between the entities. For example, Google provides a search engine and allows entities to pay for advertising, but the payment is between the advertiser and Google as opposed to between the advertiser and the entity offering an advertising opportunity. The AdBrite System, see www.adbrite.com, is similar, but AdBrite still does not allow the advertisers and publishers to directly communicate with each other to negotiate deals. AdBrite always inserts itself in the middle.

Still further, in all of the available advertising systems, there are no provisions that would allow peers to identify the characteristics of interest to them using parameter/value pairs in which the peer could add (directly or by suggestion) its own parameters. Peers are limited to the set of parameters chosen by the operator of the marketplace. For example, if a publisher wanted to limit advertisements on its site to those having images of people, or only to those have anime type drawings, there is no possibility of adding parameters to enforce those limitations in currently available systems.

Thus, there remains a considerable need for more flexible advertising marketplaces.

### SUMMARY OF THE INVENTION

The present inventive subject matter provides systems, methods, and software in which advertisers and publishers can: (1) make payments to each other rather than through a marketplace account; and/or (2) identify types, geographic locations, fees, and other relevant characteristics as parameter/value pairs, and add or at least suggest their own parameters.

In one embodiment a marketplace comprises an information system having a memory storing characteristics of an advertising opportunity associated with a first entity, or, in other words, a first peer. The marketplace also comprises an interface for use by a second entity, or second peer, to access the information system. The interface provides the second entity the ability to search through the information system to find the advertising opportunity as a function of the characteristic of the opportunity. Furthermore, the marketplace comprises an account server used by the second entity to pay for access to the information system. Also the account server can be used by the first or second entity to exchange payment between each other for access to the advertising opportunity.

In more specific embodiments, the marketplace also presents the interface to the first entity where the first entity can update information about themselves, advertising opportunities they offer, or to also to pay for access to the information system. The information can comprise a database located on one or more computer systems where the interface to the information system can be access by an entity or by a computer, possibly using an API. Also, the characteristic associated with the advertising opportunity stored in the information system can include actual content, metadata, or parameters associated with the opportunity provided by the first entity.

In other embodiments, the inventive subject matter includes methods of generating revenue. Revenue is generated by providing an information system storing a characteristic of an advertising opportunity associated with a first entity, providing and interface to allow a second entity to access the information system, and providing an account server used by the second entity to pay for access to the information system. The second entity can use the account server to pay the first peer for advertising services the first entity renders. Furthermore, the account server also allows for charging the first entity or the second entity for use of the information system, possibly on a subscription basis or on a percentage basis.

Glossary

The following descriptions refer to terms used within this document. The terms are provided to ensure clarity when discussing the various aspects of the invention matter without implied limitations.

The term “peer” means an entity that wishes to access the goods and services of another entity. A peer is different than a consumer or a provider of goods and services because a peer can embody both consumer and provider characteristics. In addition a peer can represent a single individual or a collection of multiple individuals. An example of a collection of individuals include for a profit company, a corporation, or a business; or a non-profit organization. A peer can also represent an automated system under the control of an entity, for example, a computer programmed to interface with embodiments of the inventive subject matter to maximize advertising return on investment. In the preferred embodiment, a peer can advertise as well as offer advertising opportunities.

The teachings herein may be advantageously employed by peers that have a desire to advertise and/or have advertising opportunities available for advertising. Marketplaces aid in stretching a peer's advertising dollar while also increasing advertising revenue by allowing advertising peers to find each other quickly and exchange payment without making excessive payments to a middle man.

Various objects, features, aspects, and advantages of the present invention will become more apparent from the following detailed description of the preferred embodiments of the invention, along with the accompanying drawings in which like numerals represent like components.

### BRIEF DESCRIPTION OF THE DRAWINGS

FIG. 1 represents an example embodiment of a marketplace for advertising.

### DETAILED DESCRIPTION

The follow description includes one or more specific example embodiments that are presented to clarify the inventive subject matter. However, the example embodiments do not limit the scope of the subject to the specifics of the example.

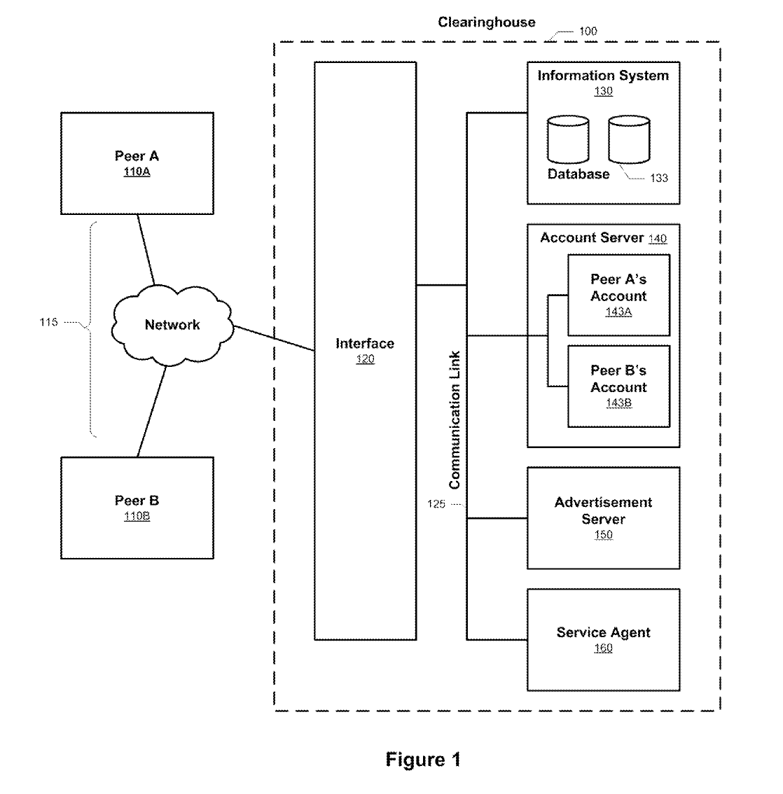

FIG. 1 presents an overview of an environment in which an embodiment exists. Marketplace 100 comprises several components that provide access to advertising opportunities to one or more peers as indicated by peers 110A and 110B. Peers 110A or 110B communicate with marketplace 100 through network 115 which communicatively couples the one or more peers to marketplace 100. Preferred marketplace 100 comprises interface 120, information system 130, and account server 140. Additionally, marketplace 100 can comprise advertising server 150 and service agent 160. The components of marketplace 100 communicate with other components through communication link 125.

Peers 110A or 110B comprises entities that use marketplace 100 to find advertising opportunities by searching through information system 130 via interface 120. In a preferred embodiment peer 110A or 110B comprise a general purpose computing system running on a general purpose operating systems, possibly Linux, Windows™, or Solaris. It is also contemplated that peer 100A or 110B could comprise dedicated hardware or software that interacts with marketplace 100. A user directs the computer directly or indirectly to find relevant opportunities. Direct use includes a person searching information system 130 by sifting through records in database 133. Indirect use includes using an automated program that sifts through the records while a user is not present.

Peer 110A communicates over network 115 to exchange information with marketplace 100. A preferred network 115 includes the Internet; however, other networks are also contemplated including wired or wireless networks. Example wired networks include those that employ frame relay, ATM, phone lines, cable lines, Ethernet, or other media that use physical infrastructure for signal transport. Example wireless networks include 802.11. UWB, WiMAX, Bluetooth, wireless USB, or other wireless transports.

Peer 110A uses interface 120 to interact with marketplace 100. Interface 120 can comprise a human interface or machine interface. In a preferred embodiment, interface 120 comprises a one or more web pages served to a browser located on peer 110A; however, it is contemplated that interface 120 could also be a dedicated application located on peer 110A. In this sense, the preferred embodiment uses a human interface that allows a human to interact with marketplace 100 directly. In an alternative embodiment, interface 120 comprises a machine interface that allows peer 110A that is operating as a machine or device to access marketplace 100. Example machine interfaces include Application Program Interfaces (APIs). In some embodiments, APIs include web services possibly using XML, SOAP, or WSDL. Although interface 120 is shown external to peer 110A, one should note interface 120 can be located physically within peer 110A, within a server within marketplace 100, or distribute across one or more devices attached to network 115.

As peer 110A interacts with interface 120, interface 120 exchanges information with one or more components of marketplace 100 over communication link 125. In some embodiments, communication link 125 includes an API between programs running on the same computer systems where the programs represent the components of marketplace 100. In a preferred embodiment, communication link 125 could employ a network to communicate between one or more computer systems. It is also contemplated that communication link 125 could comprise network 115. Communication link 125 could also comprise other types of connections between components including USB, various PCI busses, IrDA, 802.11, Ethernet, or other interconnects.

Information system 130 comprises information about one or more advertising opportunities associated with peer 110A or 110B. The information can include direct or indirect information about a peer's advertising opportunity. Direct information includes characteristics of the advertising opportunity including the target market, audience, cost, allowed advertising parameters (size, shape, word count, time length, etc . . . ), or other contemplated defining characteristics. Indirect information includes metadata, user assigned tags, classified goods and services, or other information that might not be assigned by the peer offering the advertising opportunity.

A peer, including peer 110A or peer 110B, access information system 130 to either add information about an advertising opportunity or find an advertising opportunity. In a preferred embodiment, when a peer adds an advertising opportunity, they characterize the advertising opportunity. For example, a peer could be a blogger who posts messages about fly fishing and wishes to offer advertisers access to advertising opportunities on their blog. The blogger could add the opportunities one at a time, or collectively showing how many opportunities have the same characteristics. Then the blogger characterizes the opportunities possibly by including information about the target audience; fly fishing hobbyists. A second peer, possibly a manufacturer of flies, can search information system 130 using interface 120 to find the blogger's opportunities by searching for “fly fishing” or searching using other well known techniques; possibly even using Google-like capabilities.

In a preferred embodiment, information system 130 comprises database 133. Database 133 can be implemented using any acceptable data structures including MYSQL™, Access™, Postgress™, or even web based databases including Yahoo!™, Google, MSN™, or other information stores.

Marketplace 100 can also comprise account server 140. In a preferred embodiment, account server 140 includes account 143A for peer 110A or account 143B for peer 110B. Each account is used to manage user accounts for accessing marketplace 100, for handling payments to the marketplace, or for handling payments between peers. Examples of account servers include services like Paypal or Google Pay. It is also contemplated that account server 140 can include security capabilities to ensure confidentiality, integrity, or authentication of peer data or actions.

Account service 140 allows peer 110A to charge peer 110B for placing an advertising message within peer 110A's advertising opportunity. A charge includes a monetary value, usually greater than zero dollars; however, it is also contemplated that peer 110A and 110B could exchange other forms of payment. An example of another form of payment includes providing services. For example, peer 110B could provide advertising opportunities to peer 110A in exchange for access to peer 110A's advertising opportunities. In one embodiment, marketplace 100 uses account server 140 to exchange payment between peers 110A and 110B substantially at the time when the advertisement is made; however, it is also contemplated that peers could exchange payments before or after a message is placed. It is also contemplated that account server 140 can also charge a percentage of the monetary exchange between peer 110A and 110B. The percentage, in a preferred embodiment, represents a charge for access to marketplace 110. Preferred percentages are those that have a value that are at least the value of one of the following percentages: 1%, 2%, 5%, 10%, 25%, or 50%.

Additionally, it is contemplated that marketplace 100 comprises advertisement server 150. Advertisement server 150 represents the functionality of providing an advertisement message that corresponds to an advertising opportunity.

In one embodiment, peer 110A places information about an advertising opportunity into information system 130. Peer 110B finds the opportunity and pays Peer 110A through account server 140 to place an advertisement. Peer 110B places its advertisement into advertisement server 150. When peer 110A has a chance to display the advertisement, peer 110A contacts advertisement server 150 to obtain the advertisement. In a preferred embodiment, advertisement server 150 comprises a computer server running a web server, possibly Apache. Peer 110A could offer advertising opportunities on their blog, web page, web site, or other on-line places. Peer 110A uses HTTP, possibly over an SSL connection, to obtain an advertisement. It is contemplated that the advertisement could include HTML, graphics, audio, video, text, or other communications media that can carry a message.

Service agent 160 can also compose marketplace 100. Service agent 160 comprises one or more application programs running on one or more computer systems to conduct miscellaneous tasks. Example tasks include charging each peer periodically using account server 140. In one embodiment a peer subscribes to marketplace 100 services in exchange for a periodic charge. Example periodic charges include charging on at least one of the following periods: a day, a week, a month, a quarter, a year, or a multi-year period.

Service agent 160, in some embodiments, also supplies other capabilities to a peer to aid in connecting advertising messages with advertising opportunities. Example capabilities include:
Monitoring use of a message
Alerting a peer when new advertising opportunities become available, possibly through considerations or when new opportunities are added to the information system
Logging statistics of the number of times a message has been placed or statistics on sell-through
Keeping an inventory of messages or opportunities available to peers
Generating reports, possibly in comma separated value (CSV) spreadsheets.
Other services that a peer would find useful in managing their advertising campaign

It is contemplated that marketplace 100 has to be initialized to establish a customer base. In some embodiments, information system 100 can be initialized by crawling indexed web sites similar to Yahoo! or Google to find potential advertising opportunities. Service agent 160 can send emails to those peers that have opportunities and messages. The emails could offer the peers access to marketplace 100 and show how the peers can save money by exchanging money directly without paying a substantial portion to a third party.

Additional considerations contemplated with respect to the development and deployment of marketplace 100. The following list briefly describes the additional considerations:
Peers are able to find each other's opportunities or messages through a search engine. In a preferred embodiment, standard search engines can be used including Google's search technology using keyword. Additionally, users can search for peers based on classification of opportunities or messages, or based on metadata including user defined tags or rankings.
Advertising opportunities or messages can be defined by characteristics. Characteristics comprises descriptions including word count, shape, time, position, length, volume, file size (bytes), or other parameters that can be used to describe a advertising opportunity or message.
Advertising can be as simple as a peer loading their message into advertisement server 150, then setting the parameters for their campaign with respect to other peer's opportunities. Every time the message is accessed, the peer's accounts are updated. In this sense, a peer can create a program to maximize the extent of their advertising dollar. Additionally, peers offering advertising opportunities can programmatically place messages that increase their revenue. Programmatically placing messages provides for a peer to place real-time messages which can be help optimize message metrics including click-through, buy-through, or other metric.

Although a preferred embodiment includes peers offer advertising opportunities on web sites and displaying advertising messages on the web sites, it is expressly contemplated that the inventive subject matter can be advantageously deployed in other embodiments. The following incomplete list represents possible other embodiments:
Peers can include movie theaters that have can display commercials before a movie. Local business could load content into the marketplace and pay the movie theater directly for displaying their message.
Peers can include on-line game companies that have in-game advertising. When a person plays the game, the game access advertisements from the marketplace and displays them to the game player. The advantage is that local companies could display ads as opposed to only those large companies that can pay for product placement.

Those skilled in the art of advertising or ecommerce will recognize the benefits of a peer to peer marketplace for advertising. It is contemplated that companies that make a large amount of revenue from advertising would prefer that a marketplace system not exist because it obviates their services. Peers would rather work directly with each other because the costs would be reduce for placing ads and the peers offering advertising opportunities would obtain a larger share of the revenue. By flatting the advertising market through a marketplace, the advertising market becomes a true free market where the peers generate the greatest benefit as opposed to the invasive brokerage houses. The marketplace makes revenue through subscription service, through charging a percentage of the transaction, advertising, or other less intrusive methods to the peers.

Additionally, use of a marketplace provides peers for monitoring click fraud directly because the peer ultimately decides where messages are place or who will place messages. The marketplace can be self policing or regulating.

Hardware

Other aspects relate to hardware associated with the inventive subject matter. It is contemplated that one could develop hardware for storing, prototyping, manufacturing, manipulating, managing, packaging, testing, physically controlling or supporting, or for other activities associated with the physical aspects of the inventive subject matter. Therefore, the inventive subject matter includes systems, methods, or apparatus for developing, producing, manufacturing, or running the hardware. In this sense, the hardware falls within the scope of the inventive subject matter.

Software

In still another aspect, it is contemplated that one could write software that would configure, simulate, or manage various aspects of the inventive subject matter and their associated infrastructure. From that perspective the inventive subject matter includes methods of writing such software, recording the software on a machine readable form, licensing, selling, distributing, installing, or operating such software on suitable hardware. Moreover, the software per se is deemed to fall within the scope of the inventive subject matter.

Of particular interest are electronic marketplaces in which peers could list the characteristics of interest (e.g., type of advertising, size of advertisement, time of day that an advertisement runs, keywords or other triggers for displaying the advertisement, priority over other advertisements, price for displaying, clicking through or taking some other action relative to an advertisement) as parameter/value pairs, in which new parameters could be added or at least suggested by the peers. Suggestion of new parameters for both goods and services in such as system is taught in Ser. No. 11/550,490, titled “Systems & Methods For Storing And Retrieving Goods & Services Information Using Parameter/Value Databases” to the current inventor.

Thus, specific compositions and methods of peer-to-peer advertising have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A marketplace for advertising, comprising:
(a) an information system having a memory storing a characteristic of an advertising opportunity associated with a first peer;
(b) an interface for use by a second peer to access the information system;
(c) an account server for use by the second peer to pay for use of the information system; and
wherein the interface is adapted to provide the second peer search capabilities to find the advertising opportunity as a function of the characteristic, and where at least one of the peers can identify the characteristic to the marketplace as a the parameter/value pair and automatically suggest new parameters to the marketplace.

2. The marketplace of claim 1, wherein the account server is adapted to allow the first peer to charge a payment to the second peer for access to the advertising opportunity.

3. The marketplace of claim 2, wherein the payment comprises a periodic charge.

4. The marketplace of claim 2, wherein the payment comprises a percentage of a transaction between the first peer and the second peer.
